(19) United States
(12) Patent Application Publication
(10) Pub. No.: US 2011/0015990 A1
(43) Pub. Date: Jan. 20, 2011

(54) Advertising Based on a Dynamic Ad Taxonomy

(76) Inventor: Mehul Sanghavi, Sunnyvale, CA (US)

Correspondence Address: Stattler-Suh PC, 60 SOUTH MARKET, SUITE 480, SAN JOSE, CA, 95113, US

(21) Appl. No.: 12/504,095

(22) Filed: Jul. 16, 2009

(51) Int. Cl. G06Q 30/00

(52) U.S. Cl. 705/14.43; 705/14.53; 705/14.73; 705/400; 705/28; 705/14.4

(57) ABSTRACT

A method and a system are provided for advertising based on a dynamic ad taxonomy. In one example, the system receives a static ad taxonomy at a server. The static ad taxonomy is a static ad hierarchy for categorizing products and/or services. The system receives at the server dynamic consumer behavior data from one or more consumer devices. The dynamic consumer behavior data includes dynamic navigation data and dynamic search data. The system calculates one or more dynamic categories. The dynamic categories are based on occurrences of data in the dynamic navigation data and in the dynamic search data. The system generates a dynamic ad taxonomy by editing the static ad taxonomy according to the one or more dynamic categories. The system then delivers one or more ads to a consumer device based on the dynamic ad taxonomy.

### FIELD OF THE INVENTION

The invention relates to online advertising. More particularly, the invention relates to online advertising based on a dynamic ad taxonomy.

### BACKGROUND

An advertiser, such as Ford® or McDonald's®, generally contracts a creative agency for ads to be placed in various media for the advertiser's products. Such media may include TV, radio, Internet ads (e.g., banner display ads, textual ads, streaming ads, mobile phone ads) or print media ads (e.g., ads in newspapers, magazines and posters). It is quite possible that the advertiser may engage one or more creative agencies that specialize in creating ads for one or more of the above media. A company wants to show the most relevant ads to consumers in order to get the most value from their ad campaign.

A company like Yahoo!® gathers enormous amounts of data related to IP (Internet Protocol) addresses of consumer computers. For example, the company may gather event data, including data related to consumer behavior on the Internet. Such behavior may include, for example, searches and clicks on hyperlinks. The company sees IP addresses from which the company can usually infer zip codes and even street-level data. The company sees login information and sees the pages that consumers visit. The company may infer age, gender, income and other demographic information from analyzing the pages a consumer visits even if the consumer never does a search. The company may also gather valuable search data when consumers perform search queries. All of this data is highly valuable to any company that advertises because the data may help the company advertise in the most effective way.

An advertiser that utilizes data from a company like Yahoo!® wants to show the most relevant ads to consumers in order to get more clicks on the ads. In order to do this, the advertiser needs to gather consumers' events, such as search behavior, click behavior and other browsing behavior. The company may then use these events to target relevant ads to different consumers.

In CPM (cost per thousand impressions) advertising, there are two important events that go through a data pipeline—search events and click events. Search events occur when a consumer performs a search query. Click events occur when a consumer clicks on a hyperlink or a sponsored text ad. Web servers of a company like Yahoo!® collect search events when a consumer performs a query on the company's search page. Hyperlinks and URLs (Universal Resource Locators) of the ads on the search result web page may contain the click event information. An advertiser may want to collect and analyze the search and click events in order to build a model for query-to-text ad relevance. If the advertiser can learn which ads are more relevant, then the advertiser can target these ads to consumers and get a higher CTR (click-through rate).

The amount of data gather by a company like Yahoo!® is tremendous. The amount of data is typically in the order of petabytes per day. Unfortunately, a conventional system provides static ad taxonomies to advertisers. Static taxonomies do not allow advertisers to target consumers in an cost-effective, efficient manner.

### SUMMARY

What is needed is an improved method having features for addressing the problems mentioned above and new features not yet discussed. Broadly speaking, the invention fills these needs by providing a method and a system for advertising based on a dynamic ad taxonomy.

In one embodiment, a computer-implemented method is provided comprising the following: receiving a static ad taxonomy at a server, wherein the static ad taxonomy comprises a static ad hierarchy for categorizing at least one product or service; receiving dynamic consumer behavior data from one or more consumer devices at said server, wherein the dynamic consumer behavior data comprises at least one of dynamic navigation data or dynamic search data. The method also comprises generating a dynamic ad taxonomy at said server by performing the following: calculating one or more dynamic categories, wherein the dynamic categories are based on occurrences of data in the dynamic navigation data or in the dynamic search data; and editing the static ad taxonomy according to the one or more dynamic categories.

In another embodiment, a system is provided comprising at least one server. The server is configured for the following: receiving a static ad taxonomy, wherein the static ad taxonomy is a static ad hierarchy for categorizing at least one of products and services; receiving dynamic consumer behavior data from at least one consumer device, wherein the dynamic consumer behavior data includes dynamic navigation data and dynamic search data. The server is also configured for generating a dynamic ad taxonomy at the at least one server by performing the following: calculating one or more dynamic categories, wherein the dynamic categories are based on occurrences of data in the dynamic navigation data and in the dynamic search data; and editing the static ad taxonomy according to the one or more dynamic categories. In still another embodiment, a computer readable medium comprises one or more instructions, when executed by one or more processors, cause the one or more processors to perform the steps of: receiving a static ad taxonomy at a server, wherein the static ad taxonomy comprises a static ad hierarchy for categorizing at least one product or service; receiving dynamic consumer behavior data from one or more consumer devices at said server, wherein the dynamic consumer behavior data comprises at least one of dynamic navigation data or dynamic search data. An additional step involves generating a dynamic ad taxonomy at said server by performing the following: calculating one or more dynamic categories, wherein the dynamic categories are based on occurrences of data in the dynamic navigation data or in the dynamic search data; and editing the static ad taxonomy according to the one or more dynamic categories.

The invention encompasses other embodiments configured as set forth above and with other features and alternatives. It should be appreciated that the invention can be implemented in numerous ways, including as a method, a process, an apparatus, a system or a device.

### BRIEF DESCRIPTION OF THE DRAWINGS

The invention will be readily understood by the following detailed description in conjunction with the accompanying drawings. To facilitate this description, like reference numerals designate like structural elements.

FIG. 1 is a high-level block diagram of a system for advertising based on a dynamic ad taxonomy, in accordance with some embodiments;

FIG. 2 is an example of a static ad taxonomy, in accordance with some embodiments;

FIG. 3 is a schematic diagram of a system for advertising based on a dynamic ad taxonomy, in accordance with some embodiments;

FIG. 4 is an example of a dynamic ad taxonomy, in accordance with some embodiments;

FIG. 5 is a flowchart of a method for advertising based on a dynamic ad taxonomy, in accordance with some embodiments; and

FIG. 6 is a diagrammatic representation of a network, including nodes for client systems, nodes for server systems, nodes for network infrastructure, any of which nodes may comprise a machine configured for executing instructions.

### DETAILED DESCRIPTION

An invention is disclosed for a method and a system for advertising based on a dynamic ad taxonomy. Numerous specific details are set forth in order to provide a thorough understanding of the invention. It will be understood, however, to one skilled in the art, that the invention may be practiced with other specific details.

### Definitions

Some terms are defined below in alphabetical order for easy reference. These terms are not rigidly restricted to these definitions. A term may be further defined by its use in other sections of this description.

“Ad Taxonomy” means a map of how a publisher/advertiser may categorize ads for an ad campaign. An ad taxonomy may be a hierarchy of static nodes of a static ad taxonomy, or may be a hierarchy of dynamic facets of a dynamic ad taxonomy.

“Advertiser” means an entity that is in the business of advertising a product. An advertiser may include without limitation a seller and/or a third-party agent for the seller.

“Category” means a static node or a dynamic facet of an ad taxonomy. An ad taxonomy may be static or dynamic.

“Client” means the client part of a client-server architecture. A client is typically a consumer device and/or an application that runs on a consumer device. A client typically relies on a server to perform some operations. For example, an email client is an application that enables a consumer to send and receive e-mail via an email server. The computer running such an email client may also be referred to as a client.

“Consumer” means an entity that seeks to obtain events. Examples of a consumer include without limitation an advertiser and an advertiser agent. The term “consumer” may refer to a consumer device, depending on the context. A consumer device is a computer that a consumer may use to communicate with a data distributor and/or a network, among other things.

“Consumer device” (e.g., “computer” or “consumer computer” or “client” or “server”) means a single computer or to a network of interacting computers. A consumer device is a combination of a hardware system, a software operating system and perhaps one or more software application programs. Examples of a consumer device include without limitation a laptop computer, a palmtop computer, a smart phone, a cell phone, a mobile phone, an IBM-type personal computer (PC) having an operating system such as Microsoft Windows®, an Apple® computer having an operating system such as MAC-OS, hardware having a JAVA-OS operating system, and a Sun Microsystems Workstation having a UNIX operating system.

“Database” means a collection of data organized in such a way that a computer program may quickly select desired pieces of the data. A database is an electronic filing system. In some instances, the term “database” is used as shorthand for “database management system”.

“Device” means hardware, software or a combination thereof. A device may sometimes be referred to as an apparatus. Examples of a device include without limitation a software application such as Microsoft Word®, a laptop computer, a database, a server, a display, a computer mouse, and/or a hard disk.

“Consumer” means a user of a consumer device. A consumer is typically a person who seeks to acquire a product or service. For example, a consumer may be a woman who is browsing Yahoo!® Shopping for a new cell phone to replace her current cell phone.

“Event” means data related to an action carried out by a consumer. Examples an event include without limitation click information, login information, and/or search information, among other types of information.

“Event stream” means a data stream of actions that are carried out by one or more consumers. For example, a data distributor may receive an event stream from a web server that receives events from consumers.

“Facet” means a node of a dynamic ad taxonomy.

“Marketplace” means a world of commercial activity where products and/or services are browsed, bought and/or sold. A marketplace may be located over a network, such as the Internet. A marketplace may also be located in a physical environment, such as a shopping mall.

“Network” means a connection, between any two or more computers, that permits the transmission of data. A network may be any combination of networks, including without limitation the Internet, a local area network, a wide area network, a wireless network and a cellular network.

“Publisher” means an entity that publishes, on a network, a web page having content and/or ads.

“Server” means a software application that provides services to other computer programs (and their users), in the same or other computer. A server may also refer to the physical computer that has been set aside to run a specific server application. For example, when the software Apache HTTP Server is used as the web server for a company's website, the computer running Apache is also called the web server. Server applications can be divided among server computers over an extreme range, depending upon the workload.

“Software” means a computer program that is written in a programming language that may be used by one of ordinary skill in the art. The programming language chosen should be compatible with the computer by which the software application is to be executed and, in particular, with the operating system of that computer. Examples of suitable programming languages include without limitation Object Pascal, C, C++ and Java. Further, the functions of some embodiments, when described as a series of steps for a method, could be implemented as a series of software instructions for being operated by a processor, such that the embodiments could be implemented as software, hardware, or a combination thereof. Computer readable media are discussed in more detail in a separate section below.

“System” means a device or multiple coupled devices. A device is defined above.

“Web browser” means any software program which can display text, graphics, or both, from web pages on web sites. Examples of a web browser include without limitation Mozilla Firefox® and Microsoft Internet Explorer®.

“Web page” means any documents written in mark-up language including without limitation HTML (hypertext mark-up language) or VRML (virtual reality modeling language), dynamic HTML, XML (extended mark-up language) or related computer languages thereof, as well as to any collection of such documents reachable through one specific Internet address or at one specific web site, or any document obtainable through a particular URL (Uniform Resource Locator).

“Web server” refers to a computer or other electronic device which is capable of serving at least one web page to a web browser. An example of a web server is a Yahoo® web server.

“Web site” means at least one web page, and more commonly a plurality of web pages, virtually connected to form a coherent group.

### Overview of Architecture

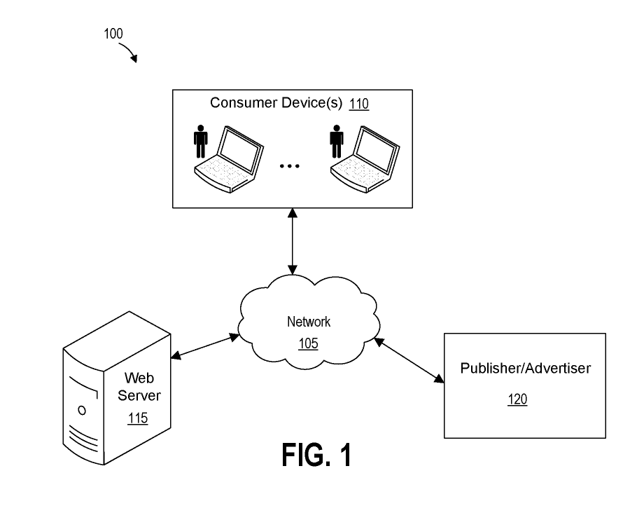

FIG. 1 is a high-level block diagram of a system 100 for advertising based on a dynamic ad taxonomy, in accordance with some embodiments. The network 105 couples together one or more consumer devices 110, a web server 115, and a publisher/advertiser 120. The network 105 may be any combination of networks, including without limitation the Internet, a local area network, a wide area network, a wireless network and/or a cellular network.

A consumer device 110 includes a single computer or a network of interacting computers. Examples of a consumer device include without limitation a laptop computer, a palmtop computer, a smart phone, a cell phone and a mobile phone. A consumer communicates over the network 105 by using a consumer device 110. A consumer may be, for example, a person browsing or shopping on the Internet.

The web server 115 includes a computer system or other electronic device that is capable of serving one or more web pages to a web browser. An example of a web server is a Yahoo® web server.

The publisher/advertiser 120 includes a publisher and/or an advertiser. A publisher is an entity that publishes, on the network 105, a web page having content and/or ads. An advertiser is an entity that is seeking to market products and/or services to the consumers at the consumer devices 110. Examples of a publisher/advertiser 120 include without limitation Yahoo!®, Amazon and Nike.

### Advertising Based on a Dynamic Ad Taxonomy

Advertising based on a dynamic ad taxonomy allows publishers and/or advertisers to target consumers in a more efficient manner than if using only a static ad taxonomy. A dynamic ad taxonomy is preferably based on a static ad taxonomy and dynamic consumer behavior data.

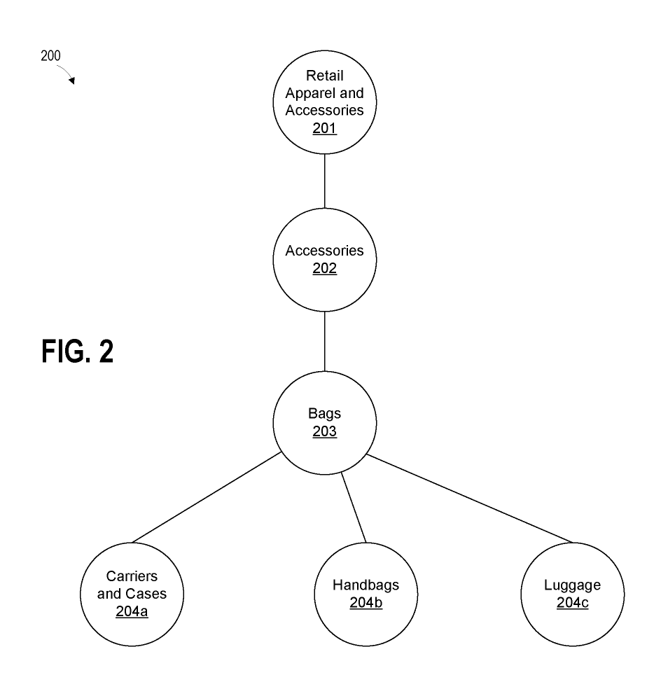

FIG. 2 is an example of a static ad taxonomy 200, in accordance with some embodiments. Conventional ad systems use a static ad taxonomy that includes a high-level static ad hierarchy for categorizing a wide range of products and/or services. For example, the static ad taxonomy 200 includes a relatively simple tree of static categories (e.g., nodes) into which an advertiser may place ads. For example, the static ad taxonomy 200 includes a main static category 201, which is “Retail Apparel and Accessories”.

The static ad taxonomy 200 also includes static subcategories 202, 203, 204a, 204b and 204c. Static subcategory 202 is “Accessories” and branches from “Retail Apparel and Accessories”. Static subcategory 203 is “Bags” and branches from “Accessories”. Static subcategory 204a is “Carriers and Cases” and branches from “Bags”. Static subcategory 204b is “Handbags” and branches from “Bags”. Static subcategory 204c is “Luggage” and branches from “Bags”.

Accordingly, a static ad taxonomy includes one or more static main categories, and one or more static subcategories branching from the static main categories. The static categories may go many levels deep depending on how broad the top level category definition is. These static categories are preferably organized in a manner that is easily understandable by an average advertiser for ad placements. A static ad taxonomy may be used for ad inventory management and for computing the minimum/maximum pricing for guaranteed and non-guaranteed ad placements. Each static category in a static ad taxonomy will have an index value that may be called by a publisher.

Static ad taxonomies reflect the publisher content organization in addition to being static category organization that can be easily understood by an average advertiser. In a lot of instances, the publisher site layout will drive the dynamic ad taxonomy markup which may not be in tune with either the user navigation path or the advertiser trying to find a suitable ad spot on the site.

Unfortunately, a static taxonomy has a shortcoming of offering a one-size-fits-all approach not only to advertisers, but also to consumers. The static categorization assumes that consumers are finding information from the top down, and that consumers will likely encounter advertiser promotions in a similar fashion. This was predominantly the case when portals like Yahoo.com and AOL.com were offering editorialized content (e.g., back in the 1990s) and consumers were forced to do top down navigation. In contrast, with Web 2.0 portal pages, content is generated dynamically from various sources. User interaction behavior is equally varied depending on the context and point of entry into the application pages. Accordingly, the one-size-fits-all approach typically does not work for every advertiser or consumer using the static ad taxonomy. A static ad taxonomy may be even more ill-fitting from a publisher/advertiser point of view.

For example, an advertiser in the luggage/handbags industry typically encounters a static ad taxonomy that looks like the static ad taxonomy 200. A static ad taxonomy is not flexible. In the static taxonomy 200, an advertiser trying to buy ad space for Luggage/Bags is out of luck. The advertiser will most likely end up doing an ad buy at the following undesired level: Retail Apparel and Accessories/Accessories/Bags. The notion of brand and pricing is also typically not encountered in static ad taxonomies, further adding to advertiser frustrations.

Fortunately, a dynamically created ad taxonomy offers advertisers a wide range of ad placement opportunities and gives the publisher a greatly enhanced capability of matching an ad to a given consumer, unlike static ad taxonomies. An ad placement model based on a dynamic ad taxonomy enables the publisher to offer a new variable pricing model that can be tweaked with “demand” dictated by the consumer behavior.

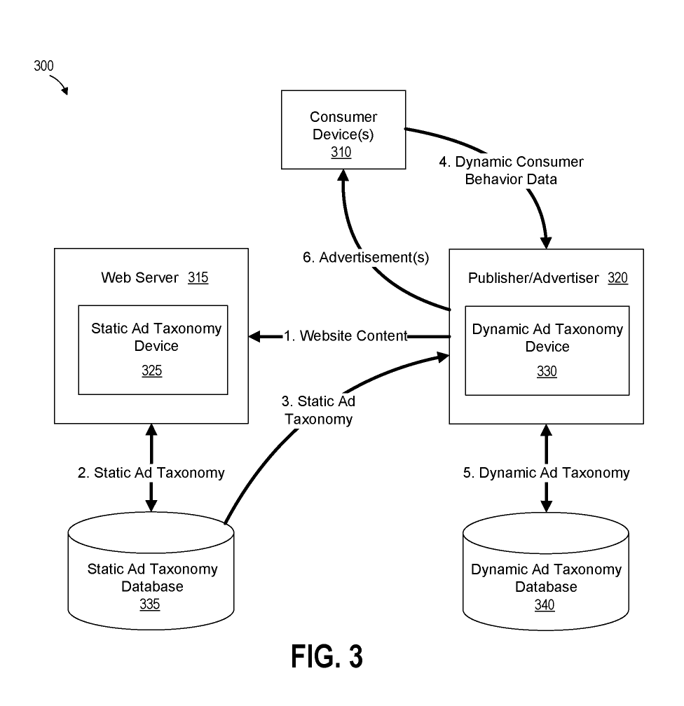

FIG. 3 is a schematic diagram of a system 300 for advertising based on a dynamic ad taxonomy, in accordance with some embodiments. The web server 315 receives consumer behavior data from one or more consumer devices 310. Consumer behavior data includes without limitation consumer searches and hyperlink clicks at a website. Such consumer behavior data is typically received from a website, such as, for example, Amazon.com or Yahoo.com.

The web server 315 includes a static ad taxonomy device 325. The static ad taxonomy generates a static ad taxonomy based on website content from the publisher 320. The static ad taxonomy is preferably stored in a static ad taxonomy database 335.

The publisher/advertiser 320 receives the static ad taxonomy from the static ad taxonomy database 335. The publisher/advertiser 320 receives the static ad taxonomy preferably after the publisher/advertiser 320 sends a request to the static ad taxonomy database 335 or to the web server 315. The publisher/advertiser 320 also receives consumer behavior data. The publisher/advertiser 320 includes a dynamic ad taxonomy device 330. The dynamic ad taxonomy device 330 generates a dynamic ad taxonomy based on the static ad taxonomy and the dynamic consumer behavior data.

Dynamic consumer behavior data includes without limitation a stream of consumer searches and hyperlink clicks at a website of a publisher 320. Examples of a website include without limitation www.amazon.com and www.borders.com. Examples of a publisher 320 include without limitation Amazon® and Borders®.

The publisher/advertiser 320 then delivers one or more ads to one or more consumer devices 310. The one or more delivered ads are based on the dynamic ad taxonomy generated by the dynamic ad taxonomy device 330.

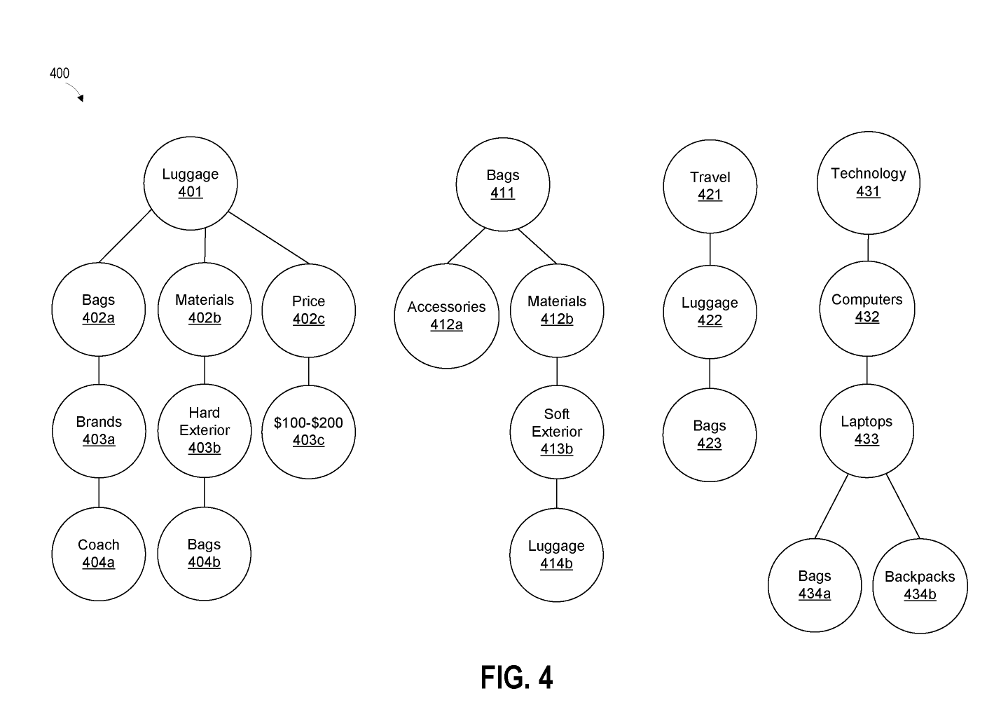

FIG. 4 is an example of a dynamic ad taxonomy 400, in accordance with some embodiments. A dynamic ad taxonomy includes tree paths for ad placement that are preferably based on at least a static ad taxonomy and consumer behavior data. For example, the dynamic ad taxonomy 400 is based on both the static ad taxonomy 200 of FIG. 2 and the dynamic consumer behavior data received by the publisher/advertiser 320 of FIG. 3. Tree paths of a dynamic ad taxonomy represent top consumer navigation paths as determined by dynamic consumer behavior.

The dynamic ad taxonomy 400 of FIG. 4 includes multiple dynamic categories (e.g., facets). Dynamic categories are based on static categories of a static ad taxonomy and on dynamic consumer behavior. For example, the dynamic categories of FIG. 4 are based on the static categories of FIG. 2 and the dynamic consumer behavior data received by the publisher/advertiser 320 of FIG. 3.

The dynamic ad taxonomy 400 of FIG. 4 includes four dynamic main categories, including “Luggage” 401, “Bags” 411, “Travel” 421 and “Technology” 431. Each dynamic main category may branch into one or more subcategories.

The dynamic main category “Luggage” 401 branches into three dynamic subcategories, including “Bags” 402a, “Materials” 402b and “Price” 402c. The dynamic subcategory branches into dynamic subcategory “Brands” 403a, which branches into dynamic subcategory “Coach” 404a. The dynamic subcategory “Materials” 402b branches into dynamic subcategory “Hard Exterior” 403b, which branches into dynamic subcategory “Bags” 404b. The dynamic subcategory “Price” 402c branches into dynamic subcategory “$100-$200” 403c.

The dynamic main category “Bags” branches into two dynamic subcategories, including “Accessories” 412a and “Materials” 412b. The dynamic subcategory “Materials” 412b branches into dynamic subcategory “Soft Exterior” 413b, which branches into dynamic subcategory “Luggage” 414b.

The dynamic main category “Travel” branches into one dynamic subcategory, which is “Luggage” 422. The dynamic subcategory “Luggage” 422 branches into dynamic subcategory “Bags” 423.

The dynamic main category “Technology” branches into one dynamic subcategory, which is “Computers” 432. The dynamic subcategory “Computers” 432 branches into dynamic subcategory “Laptops” 433, which branches into dynamic subcategories “Bags” 434a and “Backpacks” 434b.

The dynamic ad taxonomy 400 of FIG. 4 includes dynamic categories that are a result of merchandising products and/or services. Merchandizing involves adding categories to the dynamic ad taxonomy that may not be found in the corresponding static ad taxonomy. Merchandizing may also involve leaving out categories from the dynamic ad taxonomy that may be found in the corresponding static ad taxonomy. Referring again to FIG. 3, the publisher/advertiser 320 preferably edits categories from the static ad taxonomy by using the dynamic consumer behavior data received from the consumer devices 310. The dynamic consumer behavior data indicates how consumers are navigating and searching the publisher's website.

Accordingly, a portion of the dynamic consumer behavior data may include a stream of consumer navigation data. Consider, for example, the Amazon.com website having a portion of a menu system organized in a manner that is consistent with the static ad taxonomy of FIG. 2. A consumer may navigate through the menu on Amazon.com by clicking on the broad category of “Retail Apparel and Accessories”, and then clicking on the more specific category of “Accessories”, and then clicking on the even more specific category of “Bags”. The Amazon.com website may then provide, for example, 10 pages of products pertaining to the specific category of “Bags” from the menu system. The consumer may decide to stop there and browse the pages of products presented to the consumer. The publisher/advertiser receives this dynamic navigation data and may use the data for generating and updating the dynamic ad taxonomy. Other examples of navigation data exist as well.

A portion of the dynamic consumer behavior data may also include a stream of consumer search data. A search allows a consumer to go to what the consumer wants in a manner that may be more direct than navigating through menus. For example, a consumer may input a keyword search into the Amazon.com website. For instance, a consumer may search for “Bags” on Amazon.com. The Amazon.com website may return, for example, 10 pages of products pertaining to the keyword search for “Bags”. The consumer may decide to stop there and browse the pages of products presented to the consumer. The publisher/advertiser receives the dynamic search data and may use the data for generating and updating the dynamic ad taxonomy. Other examples of search data exist as well.

An important part of generating the dynamic ad taxonomy involves the manner in which the publisher/advertiser combines the search and navigation information from multiple consumers. The publisher/advertiser may encounter a situation, for example, where many consumers are searching for “Bags”, while fewer consumers are navigating from the broader category of “Retail Apparel and Accessories”. Such search behavior would be a strong indication that “Bags”, instead of “Retail Apparel and Accessories” should be a main category. Referring to FIG. 4, the publisher/advertiser duly calculates “Bags” to be a main category and arranges the dynamic ad taxonomy accordingly.

Generally, the publisher/advertiser calculates dynamic categories for the dynamic ad taxonomy according to levels of popularity in the dynamic search data and the dynamic navigation data. For example, a publisher/advertiser may calculate a particular dynamic category if the category is so heavily visited through searching and/or navigating. Examples of main dynamic categories include “Luggage”, “Bags”, “Travel” and “Technology” from FIG. 4. The publisher/advertiser may likewise arrange dynamic subcategories according to descending levels of popularity based on the dynamic search data and the dynamic navigation data. For example, the publisher/advertiser may arrange “Soft Exterior” as being a dynamic subcategory of “Materials” because many consumers may, for example, search for materials before the consumers refine their search down to soft exterior. Other examples of arranging dynamic categories exist as well.

Accordingly, Consumer behavior is dynamic and includes highly varying behavior of many different consumers. The dynamic consumer behavior affects the makeup of a dynamic ad taxonomy, such as the dynamic ad taxonomy 400 of FIG. 4. A dynamic ad taxonomy allows the advertiser to place ads more effectively because the dynamic ad taxonomy is a hierarchy that is dynamically tailored to consumer behavior.

Merchandizing may also involve product pricing and product branding, which are valuable features of the dynamic ad taxonomy 400. These features are not features of the static ad taxonomy 200 of FIG. 2. An example of product pricing is dynamic subcategory “$100-$200” 403c of FIG. 4. An example of product branding is dynamic subcategory “Coach” 404a.

It is readily apparent that that the dynamic ad taxonomy 400 includes categories that are not found in the static ad taxonomy 200 of FIG. 2. Notice also that the dynamic ad taxonomy 400 of FIG. 4 happens to exclude categories that are found in the static ad taxonomy 200 of FIG. 2.

Accordingly, a dynamic ad taxonomy gives advertisers capabilities of faceted search and navigation for ad inventory lookups and ad placements. The dynamic ad taxonomy provides dynamic tree paths that lead to targeted products and/or services. These tree paths mimic how a consumer may navigate the publisher web site. The tree paths also indicate how the publisher/advertiser delivers content and/or ads to a consumer device.

### Overview of Method for Advertising Based on a Dynamic Ad Taxonomy

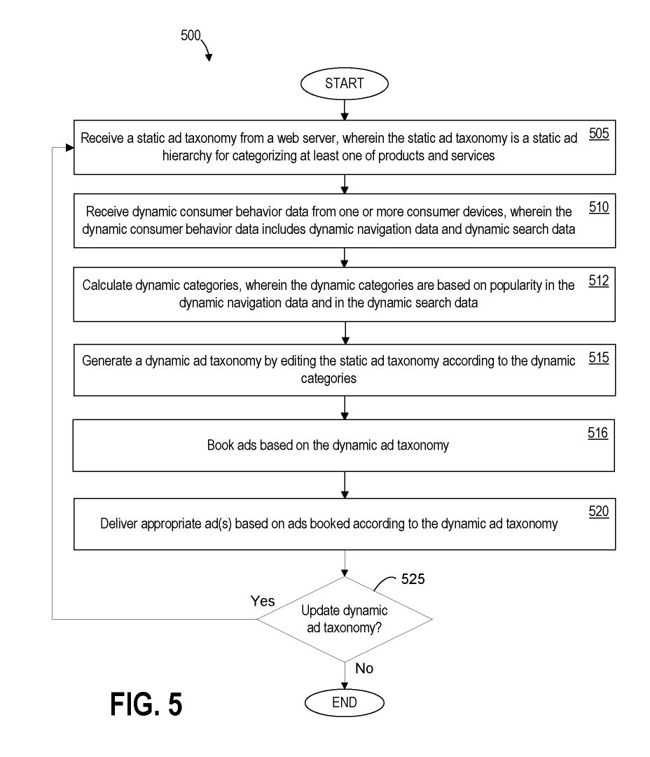

FIG. 5 is a flowchart of a method 500 for advertising based on a dynamic ad taxonomy, in accordance with some embodiments. The steps of the method 500 may be carried out by one or more devices of the system 300 of FIG. 3.

The method 500 starts in a step 505 where the system receives a static ad taxonomy from a web server. The static ad taxonomy is a static ad hierarchy for categorizing at least one of products and services. The method 500 then moves to a step 510 where the system receives dynamic consumer behavior data from one or more consumer devices. The dynamic consumer behavior data includes dynamic navigation data (e.g., a stream of consumer navigation data) and dynamic search data (e.g., a stream of consumer search data).

Next, in a step 512, the system calculates dynamic categories. The dynamic categories are based on popularity in the dynamic navigation data and in the dynamic search data. Then, in a step 515, the system generates a dynamic ad taxonomy by editing the static ad taxonomy according to the dynamic categories. Next, in step 516, the system books ads according to the dynamic ad taxonomy (e.g., dynamic ad tree). For example, a publisher/advertiser 320 of FIG. 3 may book ads according to the dynamic ad taxonomy. User navigation paths are ranked in the dynamic ad taxonomy. User navigation paths that are highly ranked demand a higher CPM (cost per thousand impressions). The ranking informs the publisher/advertiser the frequency in which that path was selected, thus, offering ad inventory forecasting for a time period. The time period may be, for example, the next day, week, month and/or year, etc. The publisher/advertiser may use the ad inventory forecasting to book an ad campaign spanning multiple time periods (e.g., multiple days). Once the advertiser booking phase is complete, the method 500 then proceeds to a step 520 where the system delivers one or more appropriate ads based on ads booked according to the dynamic ad taxonomy.

Next, in a decision operation 525, the system determines if the dynamic ad taxonomy is to be updated. If the dynamic ad taxonomy is to be updated, then the method 500 returns to the step 505 where the system receives a static ad taxonomy. However, in the decision operation 525, if the dynamic ad taxonomy is not to be updated, then the method 500 concludes after the decision operation 525. Note that the method 500 may include other details and steps that are not discussed in this method overview. Other details and steps are discussed with reference to the appropriate figures and may be a part of the method 500, depending on the embodiment.

### Exemplary Network, Client, Server and Computer Environments

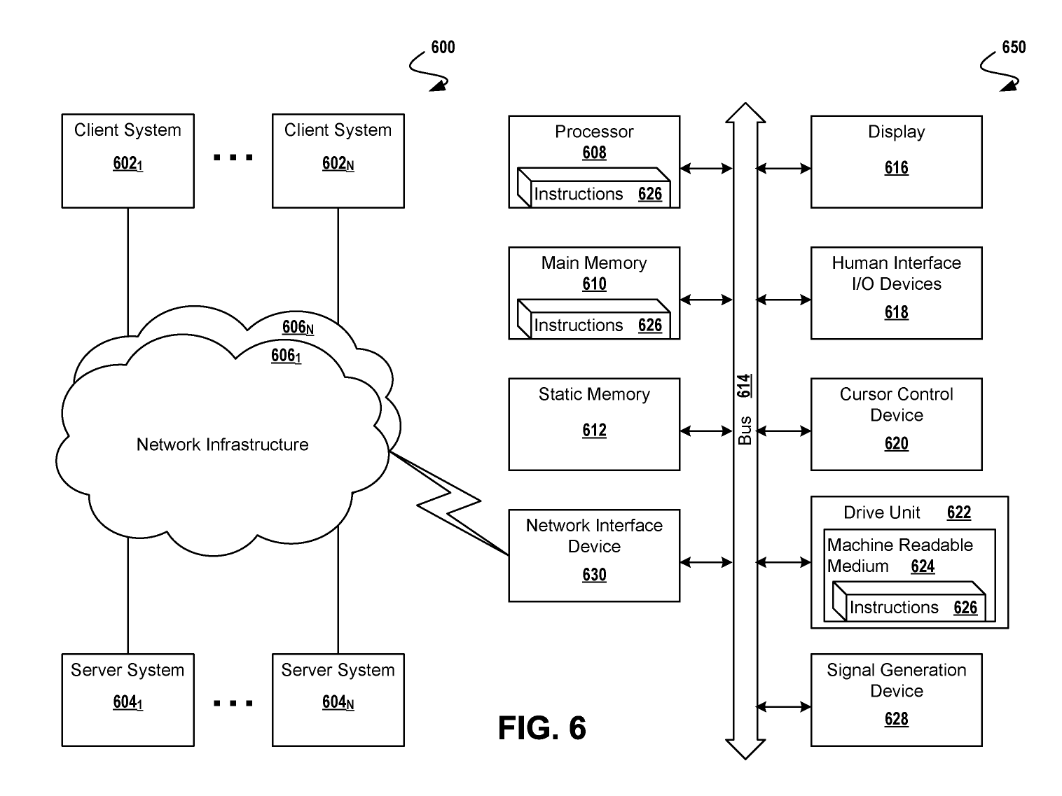

FIG. 6 is a diagrammatic representation of a network 600, including nodes for client systems 602₁ through 602_{N}, nodes for server systems 604₁ through 604_{N}, nodes for network infrastructure 606₁ through 606_{N}, any of which nodes may comprise a machine 650 within which a set of instructions for causing the machine to perform any one of the techniques discussed above may be executed. The embodiment shown is exemplary, and may be implemented in the context of one or more of the figures herein.

Any node of the network 600 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g., a client computer system, a server computer system) and/or may comprise one or more embedded computer systems, a massively parallel computer system, and/or a cloud computer system.

The computer system 650 includes a processor 608 (e.g., a processor core, a microprocessor, a computing device, etc.), a main memory 610 and a static memory 612, which communicate with each other via a bus 614. The machine 1050 may further include a display unit 616 that may comprise a touch-screen, or a liquid crystal display (LCD), or a light emitting diode (LED) display, or a cathode ray tube (CRT). As shown, the computer system 650 also includes a human input/output (I/O) device 618 (e.g. a keyboard, an alphanumeric keypad, etc), a pointing device 620 (e.g., a mouse, a touch screen, etc), a drive unit 622 (e.g., a disk drive unit, a CD/DVD drive, a tangible computer readable removable media drive, an SSD storage device, etc.), a signal generation device 628 (e.g., a speaker, an audio output, etc.), and a network interface device 630 (e.g., an Ethernet interface, a wired network interface, a wireless network interface, a propagated signal interface, etc.).

The drive unit 622 includes a machine-readable medium 624 on which is stored a set of instructions 626 (e.g., software, firmware, middleware, etc.) embodying any one, or all, of the methodologies described above. The set of instructions 626 is also shown to reside, completely or at least partially, within the main memory 610 and/or within the processor 608. The set of instructions 626 may further be transmitted or received via the network interface device 630 over the network bus 614.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

### Advantages

The system provides advertising based on a dynamic ad taxonomy. A dynamic ad taxonomy is preferably based on a static ad taxonomy and dynamic consumer behavior. With re-arrangement of various logical categories, a dynamic ad taxonomy provides enormous ad placement possibilities a context tailored for a particular publisher/advertiser. Overtime, search and navigation trends may be logged and documented. The trends may give the publisher/advertiser better yield management and pricing guarantees. From an advertiser perspective, this rich data will give insights into the type of ads/creatives the advertiser should create and how to go about optimizing ad buys.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is the following:

1. A computer-implemented method comprising:
receiving a static ad taxonomy at a server, wherein the static ad taxonomy comprises a static ad hierarchy for categorizing at least one product or service;
receiving dynamic consumer behavior data from one or more consumer devices at said server, wherein the dynamic consumer behavior data comprises at least one of dynamic navigation data or dynamic search data;
generating a dynamic ad taxonomy at said server by:
calculating one or more dynamic categories, wherein the dynamic categories are based on occurrences of data in the dynamic navigation data or in the dynamic search data; and
editing the static ad taxonomy according to the one or more dynamic categories.

2. The method of claim 1, further comprising delivering one or more ads based on the dynamic ad taxonomy.

3. The method of claim 1, wherein the static ad hierarchy includes at least one of:
one or more static main categories; and
one or more static subcategories branching from the one or more static main categories.

4. The method of claim 1, wherein the static ad taxonomy is at least one of:
understandable by an advertiser;
usable for ad inventory management;
usable for computing minimum pricing for an ad placement; and
usable for computing maximum pricing for an ad placement.

5. The method of claim 1, wherein the dynamic ad taxonomy provides at least one of:
a wide range of ad placement opportunities; and
an enhanced capability of matching an ad to a given consumer.

6. The method of claim 1, wherein the receiving the static ad taxonomy occurs after sending a request for the static ad taxonomy to at least one of:
a static ad taxonomy database; and
a web server.

7. The method of claim 1, wherein the dynamic consumer behavior data includes at least one of:
one or more consumer searches at a web site; and
one or more hyperlink clicks at the web site.

8. The method of claim 1, wherein the dynamic ad taxonomy includes at least one of:
one or more tree paths that represent top consumer navigation paths as determined by the dynamic consumer behavior data; and
one or more categories that are not in the static ad taxonomy.

9. The method of claim 1, wherein the dynamic ad taxonomy includes one or more dynamic categories that are a result of merchandising at least one of:
a product; and
a service.

10. The method of claim 9, wherein the merchandising comprises at least one of:
adding one or more categories to the dynamic ad taxonomy that are not in the static ad taxonomy;
leaving out one or more categories from the dynamic ad taxonomy that are in the static ad taxonomy;
pricing one or more products;
pricing one or more services;
branding one or more products; and
branding one or more services.

11. A system comprising:
at least one server configured for:
receiving a static ad taxonomy, wherein the static ad taxonomy is a static ad hierarchy for categorizing at least one of products and services;
receiving dynamic consumer behavior data from at least one consumer device, wherein the dynamic consumer behavior data includes dynamic navigation data and dynamic search data;
generating a dynamic ad taxonomy at the at least one server by:
calculating one or more dynamic categories, wherein the dynamic categories are based on occurrences of data in the dynamic navigation data and in the dynamic search data; and
editing the static ad taxonomy according to the one or more dynamic categories.

12. The system of claim 11, wherein the at least one server is further configured for delivering one or more ads based on the dynamic ad taxonomy.

13. The system of claim 11, wherein the static ad hierarchy includes at least one of:
one or more static main categories; and
one or more static subcategories branching from the one or more static main categories.

14. The system of claim 11, wherein the static ad taxonomy is at least one of: understandable by an advertiser;
usable for ad inventory management;
usable for computing minimum pricing for an ad placement; and
usable for computing maximum pricing for an ad placement.

15. The system of claim 11, wherein the dynamic ad taxonomy provides at least one of:
a wide range of ad placement opportunities; and
an enhanced capability of matching an ad to a given consumer.

16. The system of claim 11, wherein the receiving the static ad taxonomy is configured to occur after the system sends a request for the static ad taxonomy to at least one of:
a static ad taxonomy database; and
a web server.

17. The system of claim 11, wherein the dynamic consumer behavior data includes at least one of:
one or more consumer searches at a web site; and
one or more hyperlink clicks at the web site.

18. The system of claim 11, wherein the dynamic ad taxonomy includes at least one of:
one or more tree paths that represent top consumer navigation paths as determined by the dynamic consumer behavior data; and
one or more categories that are not in the static ad taxonomy.

19. The system of claim 11, wherein the dynamic ad taxonomy includes one or more dynamic categories that are a result of merchandising at least one of:
a product; and
a service.

20. The system of claim 19, wherein the merchandising comprises at least one of:
adding one or more categories to the dynamic ad taxonomy that are not in the static ad taxonomy;
leaving out one or more categories from the dynamic ad taxonomy that are in the static ad taxonomy;
pricing one or more products;
pricing one or more services;
branding one or more products; and
branding one or more services.

21. A computer readable medium carrying one or more instructions, when executed by one or more processors, cause the one or more processors to perform the steps of:
receiving a static ad taxonomy at a server, wherein the static ad taxonomy comprises a static ad hierarchy for categorizing at least one product or service;
receiving dynamic consumer behavior data from one or more consumer devices at said server, wherein the dynamic consumer behavior data comprises at least one of dynamic navigation data or dynamic search data;
generating a dynamic ad taxonomy at said server by:
calculating one or more dynamic categories, wherein the dynamic categories are based on occurrences of data in the dynamic navigation data or in the dynamic search data; and
editing the static ad taxonomy according to the one or more dynamic categories.
